(19) United States
(12) Patent Application Publication
(10) Pub. No.: US 2024/0080452 A1
(43) Pub. Date: Mar. 7, 2024

(54) VIDEO ENCODER AND VIDEO ENCODING METHOD WITH REAL-TIME QUALITY ESTIMATION

(71) Applicant: MEDIATEK INC., Hsinchu City (TW)

(72) Inventors: Tung-Hsing WU, Hsinchu City (TW); Chih-Hao CHANG, Hsinchu City (TW); Yi-Fan CHANG, Hsinchu City (TW); Han-Liang CHOU, Hsinchu City (TW)

(21) Appl. No.: 18/350,897

(22) Filed: Jul. 12, 2023

Related U.S. Application Data
(60) Provisional application No. 63/374,612, filed on Sep. 6, 2022.

(51) Int. Cl. H04N 19/154; H04N 19/124; H04N 19/159; H04N 19/82

(52) U.S. Cl. CPC H04N 19/154; H04N 19/124; H04N 19/159; H04N 19/82

(57) ABSTRACT

A video encoder with quality estimation is shown. The video encoder has a video compressor, a video reconstructor, a quality estimator, and an encoder top controller. The video compressor receives the source data of a video to generate compressed data. The video reconstructor is coupled to the video compressor for generation of playback-level data that is buffered for inter prediction by the video compressor, wherein the video reconstructor generates intermediate data and, based on the intermediate data, the video reconstructor generates playback-level data. The quality estimator is coupled to the video reconstructor to receive the intermediate data. Quality estimation is performed based on the intermediate data rather than the playback-level data. Based on the quality estimation result, the encoder top controller adjusts at least one video compression factor in real time.

### CROSS REFERENCE TO RELATED APPLICATIONS

This application claims the benefit of U.S. Provisional Application No. 63/374,612, filed Sep. 6, 2022, the entirety of which is incorporated by reference herein.

### BACKGROUND OF THE INVENTION

### Field of the Invention

The present invention relates to video encoders.

### Description of the Related Art

A video encoder is a device, a chip, or an IP core that can compress digital video. Usually this type of compression is destructive data compression. For example, a quantization procedure performed during video encoding may affect the video quality. However, the bit rate determines the size of the compressed video. A balance between video quality and bit rate is called for.

In response to the demand for higher video quality at lower bit rates, there is a need for quality estimation of the compressed video, and how to improve the video encoding based on the video estimation result is also an importance topic in this technical field. Based on the estimated quality, the bit rate may be dynamically adjusted to its proper value in real time. The better the compression quality is, the lower the bit rate is allowed. The coding tool may be also dynamically adjusted based on the estimated quality. However, a tradeoff between the coding efficiency and power consumption should be taken into consideration.

### BRIEF SUMMARY OF THE INVENTION

A video encoder with real-time quality estimation is shown.

In an exemplary embodiment, a video encoder with real-time quality estimation has a video compressor, a video reconstructor, a quality estimator, and an encoder top controller. The video compressor receives the source data of a video to generate compressed data. The video reconstructor is coupled to the video compressor. The video reconstructor generates playback-level data that is buffered for inter prediction by the video compressor. To generate the playback-level data, the video reconstructor generates intermediate data and, based on the intermediate data, the video reconstructor generates the playback-level data. The quality estimator is coupled to the video reconstructor to receive the intermediate data. The quality estimator performs quality estimation based on the intermediate data rather than the playback-level data. The quality estimation is used for adjusting at least one video compression factor in real time. The encoder top controller adjusts the at least one video compression in real time based on the quality estimation performed by the quality estimator.

In an exemplary embodiment, the video reconstructor has an inverse quantization unit, an inverse-transform unit, a reconstruction unit, and an in-loop filter with at least one stage. The inverse quantization unit is coupled to a quantization unit of the video compressor to perform inverse quantization, which generates inverse-quantized data. The inverse-transform unit performs an inverse transform on the inverse-quantized data to generate inverse-transformed data. The reconstruction unit receives prediction data obtained from the video compressor as well as the inverse-transformed data, to generate reconstructed data for intra-prediction by the video compressor. The in-loop filter with at least one stage processes the reconstructed data to generate playback-level data.

In an exemplary embodiment, the quality estimator is coupled to an output port of the reconstruction unit, to receive the reconstructed data as the intermediate data. The quality estimator may compare the reconstructed data with source data that corresponds to the reconstructed data to determine the quality of the video encoding.

In another exemplary embodiment, the quality estimator is coupled to an output port of the inverse-transform unit, to receive the inverse-transformed data as the intermediate data. The quality estimator may compare the inverse-transformed data with residual data corresponding to the inverse-transformed data, to determine the quality of the video encoding.

In another exemplary embodiment, the quality estimator is coupled to an output port of the inverse quantization, to receive the inverse-quantized data as the intermediate data. The quality estimator may compare the inverse-quantized data with transformed residual data corresponding to the inverse-quantized data, to determine the quality of the video encoding.

In an exemplary embodiment, the playback-level data is output from a final-stage in-loop filter. The quality estimator is coupled to an output port of any former-stage in-loop filter to receive the intermediate data. The quality estimator may compare the intermediate data with source data corresponding to the intermediate data to determine the quality of the video encoding.

In another exemplary embodiment, a video encoding method with real-time quality estimation is shown. The video encoding method includes the following steps. Video compression is performed on the source data of a video to generate compressed data. Playback-level data that is associated with the compressed data is generated and then buffered for inter prediction by the video compressor. Intermediate data associated with the compressed data is generated prior to the generation of the playback-level data. Specifically, the playback-level data is generated based on the intermediate data. Quality estimation is performed based on the intermediate data rather than the playback-level data. The quality estimation is for adjusting at least one video compression factor in real time.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 illustrates a video encoder 100 with real-time quality estimation in accordance with an exemplary embodiment of the present invention;

FIG. 2 illustrates a video encoder 200 (H.264) in accordance with an exemplary embodiment of the disclosure; and

FIG. 3 illustrates a video encoder 300 (HEVC, AV1, or VVC) in accordance with an exemplary embodiment of the disclosure.

### DETAILED DESCRIPTION OF THE INVENTION

The following description is made for the purpose of illustrating the general principles of the invention and should not be taken in a limiting sense. The scope of the invention is best determined by reference to the appended claims.

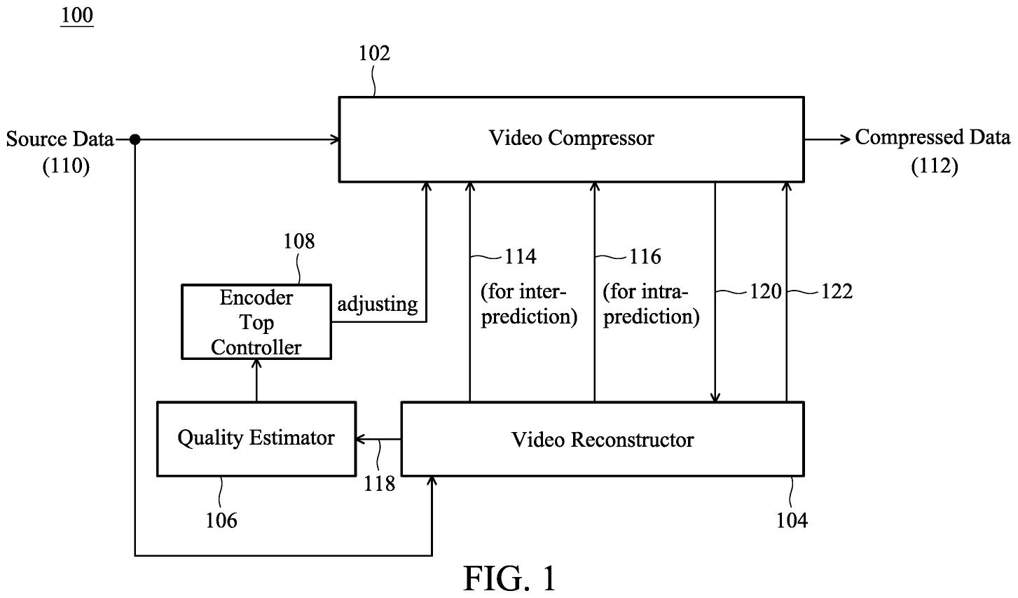

FIG. 1 illustrates a video encoder 100 with real-time quality estimation in accordance with an exemplary embodiment of the present invention. The video encoder 100 has a video compressor 102, a video reconstructor 104, a quality estimator 106, and an encoder top controller 108. The video compressor 102 receives the source data 110 of a video to generate compressed data 112 (e.g. a bit stream). The video reconstructor 104 coupled to the video compressor 102 is for generation of playback-level data 114 that is buffered for inter prediction by the video compressor 102 (this is different from the reconstructed data 116 used for intra-prediction by the video compressor 102). Note that prior to the generation of the playback-level data 114, the video reconstructor 104 generates intermediate data 118, wherein the video reconstructor 104 generates the playback-level data 114 based on the intermediate data 118. The quality estimator 106 is coupled to the video reconstructor 104 to receive the intermediate data 118. The quality estimator 106 performs quality estimation based on the intermediate data 118 to determine the encoding quality in real time. The result of the real-time quality estimation is sent to the encoder top controller 108. The encoder top controller 108 adjusts at least one video compression factor of the video encoding in real time. In this way, the video encoding quality can always be guaranteed, no matter how much the video conditions change.

In FIG. 1, there is a path 120 that transfers data from the video compressor 102 to the video reconstructor 104 for video reconstruction, and in some encoding technologies, an additional path 122 is required to transfer data from the video reconstructor 104 to the video compressor 102 for entropy coding.

The video encoder 100 is in a pipelined structure. It should be noted that the intermediate data 118 of a target block is generated earlier than its playback-level data 114. The quality estimator 106 performs quality estimation based on the intermediate data 118 rather than the playback-level data 114. Thus, less hardware (e.g., less RAM) is required to keep the proper quality estimation reference (e.g., source data of the target block) to be compared with the intermediate data 118 that is generated in the earlier pipeline stage than the playback-level data 114.

A low-cost and real-time adjusting video encoder 100 is proposed.

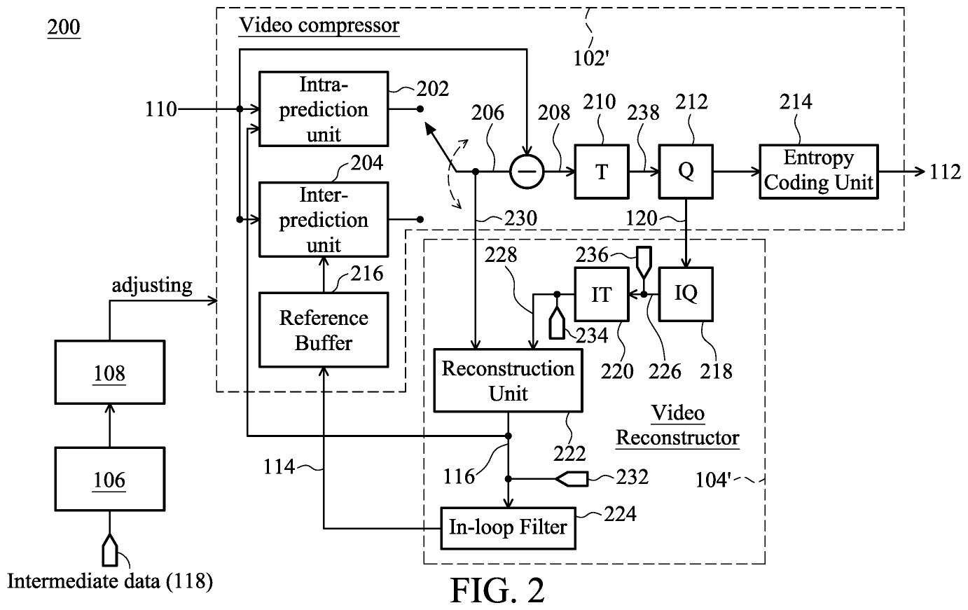

FIG. 2 illustrates a video encoder 200 in accordance with an exemplary embodiment of the disclosure. The video encoder 200 may be an H.264 encoder.

The video compressor 102′ of FIG. 2 operates an intra-prediction unit 202 and an inter-prediction unit 204 to generate prediction data 206 and then generates residual data 208. The video compressor 102′ also has a transform unit 210 and a quantization unit 212 that transform and quantize the residual data 208. The output of the quantization unit 212 is processed further by an entropy-coding unit 214 to generate the compressed data 112. The video compressor 102′ has a reference buffer 216, for collecting a reconstructed frame to input into the inter-prediction unit 204.

The video reconstructor 104′ has an inverse quantization unit (IQ) 218, an inverse-transform unit (IT) 220, a reconstruction unit 222, and an in-loop filter 224 (for single stage in-loop filtering). The inverse quantization unit (IQ) 218 is coupled to the quantization unit 212 of the video compressor 102′ to perform inverse quantization to generate inverse-quantized data 226. The inverse-transform unit (IT) 220 performs an inverse transform on the inverse-quantized data 226 to generate inverse-transformed data 228. The reconstruction unit 222 receives prediction data 230 obtained from the video compressor 102′ as well as the inverse-transformed data 228, to generate reconstructed data 116 to be sent to the intra-prediction unit 202 of the video compressor 102′. The in-loop filter 224 processes the reconstructed data 116 to generate the playback-level data 114 to be buffered in the reference buffer 216 of the video compressor 102′ to form the reconstructed frame for the inter-prediction unit 204. In this H.264 example, the path 122 is not required.

It should be noted that, in the H.264 video encoder 200, the output port 232 of the reconstruction unit 222 may be coupled to the quality estimator 106 to provide the reconstructed data 116 for use as the intermediate data 118. The quality estimator 106 may compare the reconstructed data 116 with the corresponding source data 110 (e.g., they belong to the same image block), to estimate the real-time encoding quality based on the difference between the reconstructed data 116 and the associated source data 110.

In another exemplary embodiment, an output port 234 of the inverse-transform unit (IT) 220 may be coupled to the quality estimator 106 to provide the inverse-transformed data 228 as the intermediate data 118. The quality estimator 106 may compare the inverse-transformed data 228 with the corresponding residual data 208 (e.g., they belong to the same image block), to estimate the real-time encoding quality based on the difference between the inverse-transformed data 228 and the associated residual data 208.

In another exemplary embodiment, an output port 236 of the inverse quantization (IQ) 218 may be coupled to the quality estimator 106 to provide the inverse-quantized data 226 as the intermediate data 118. The quality estimator 106 may compare the inverse-quantized data 226 with transformed residual data 238 that corresponds to the inverse-quantized data 226 (e.g., belonging to the same image block), to estimate the real-time encoding quality based on the difference between the inverse-quantized data 226 and the transformed residual data 238 associated with it.

The quality estimator 106 may show pixel distortion using peak signal-to-noise ratio (PSNR), structural similarity index measure (SSIM), video multi-method assessment fusion (VMAF), just-noticeable differences (JND), mean opinion score (MOS), differential mean opinion score (DMOS), and other metrics.

The result of the quality estimation is further sent to the encoder top controller 108 for real-time factor adjustment.

In an exemplary embodiment, the video compression factor adjusted according to the quality estimation result made by the quality estimator 106 may be an output bit rate of the bit stream (112). In an exemplary embodiment, if the estimated quality is better than a first score, the bit rate can be decreased by adjusting the quantization parameter used in the quantization unit 212 and the inverse quantization (IQ) 218. If the estimated quality is worse than a second score, the bit rate can be increased by adjusting the quantization parameter used in the quantization unit 212 and the inverse quantization (IQ) 218.

In an exemplary embodiment, the video compression factor adjusted according to the quality estimation result made by the quality estimator 106 may be the output frame rate of the bit stream (112). In an exemplary embodiment, if the estimated quality is worse than the first score, the frame rate of the source data 110 is decreased. If the estimated quality is better than the second score, the frame rate of the source data 110 is increased.

In an exemplary embodiment, the video compression factor adjusted according to the quality estimation result made by the quality estimator 106 may be the resolution of the bit stream (112). In an exemplary embodiment, if the estimated quality is worse than the first score, the resolution of the source data 110 is decreased. If the estimated quality is better than the second score, the resolution of the source data 110 is increased.

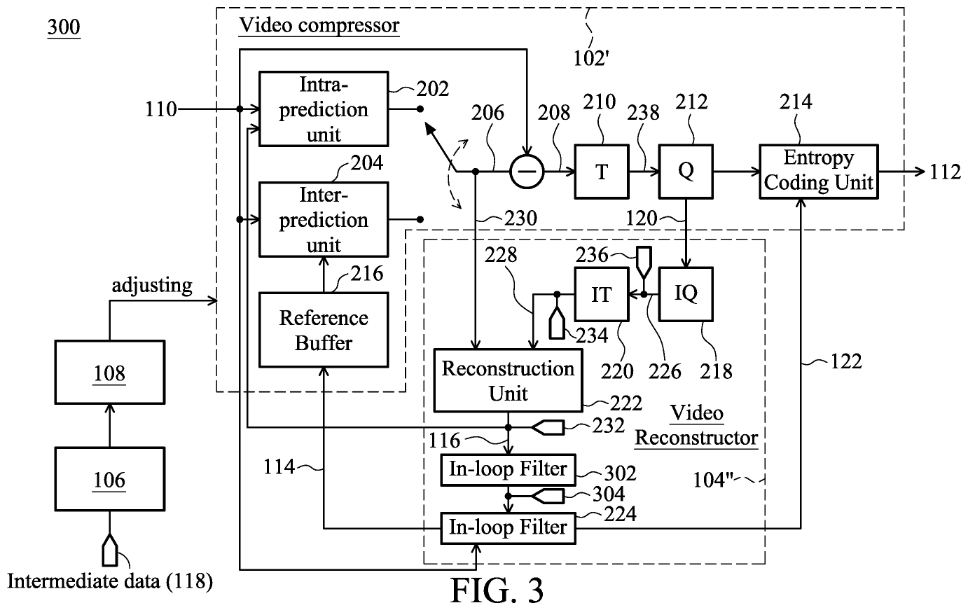

FIG. 3 illustrates a video encoder 300 in accordance with an exemplary embodiment of the disclosure. The video encoder 300 may be an HEVC, AV1, or VVC encoder.

In comparison with the H.264 video encoder 200 of FIG. 2, the video encoder 300 of FIG. 3 uses a video reconstructor 104″ that uses an in-loop filter with multiple stages (including the final-stage in-loop filter 224 and a former-stage in-loop filter 302). In this example, not only can the reconstructed data 116, the inverse-transformed data 228, and the inverse-quantized data 226 be used as the intermediate data 118, but the output port 304 of the former-stage in-loop filter 302 may also be coupled to the quality estimator 106 to provide its output signal as the intermediate data 118. The quality estimator 106 may compare the output of the former-stage in-loop filter 302 with its corresponding source data 110 (e.g., belonging to the same image block).

In some exemplary embodiments, more than two stages of in-loop filtering are used. The quality estimator 106 is coupled to the output port of any former-stage in-loop filter to receive the intermediate data 118.

The aforementioned video encoder may be a chip or an IP core. The units/modules used in the video encoder are implemented by software and hardware co-design.

A video encoding method with real-time quality estimation based on the aforementioned concept is shown. Referring to FIG. 1, the video encoding method includes performing video compression on source data 110 of a video to generate compressed data 112. The video encoding method includes generating playback-level data 114 associated with the compressed data, to be buffered for inter prediction of the video compression. Intermediate data 118 is generated associated with the compressed data 112 prior to generation of the playback-level data 114. Playback-level data 114 is generated based on the intermediate data 118. The video encoding method includes performing quality estimation based on the intermediate data 118 for adjusting at least one video compression factor of the video encoding in real time.

In the other exemplary embodiments, the video encoding method may be implemented by software that is executed by any computing system. In some exemplary embodiments, the video encoding method is implemented by a co-design of hardware and software (e.g., implemented by the encoder top controller and software).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A video encoder with real-time quality estimation, comprising:
a video compressor, receiving source data of a video to generate compressed data;
a video reconstructor, coupled to the video compressor, to generate playback-level data that is buffered for inter prediction by the video compressor, wherein the video reconstructor generates intermediate data and, based on the intermediate data, the video reconstructor generates the playback-level data;
a quality estimator, coupled to the video reconstructor to receive the intermediate data, and used for performing quality estimation based on the intermediate data; and
an encoder top controller, adjusting at least one video compression factor in real time based on quality estimation result from the quality estimator.

2. The video encoder with real-time quality estimation as claimed in claim 1, wherein the video reconstructor comprises:
an inverse quantization unit, coupled to a quantization unit of the video compressor for performing inverse quantization to generate inverse-quantized data;
an inverse-transform unit, performing an inverse transform on the inverse-quantized data to generate inverse-transformed data;
a reconstruction unit, receiving prediction data obtained from the video compressor as well as the inverse-transformed data, to generate reconstructed data for intra-prediction by the video compressor; and
an in-loop filter with at least one stage, processing the reconstructed data to generate the playback-level data.

3. The video encoder with real-time quality estimation as claimed in claim 2, wherein:
the quality estimator is coupled to an output port of the reconstruction unit, to receive the reconstructed data as the intermediate data.

4. The video encoder with real-time quality estimation as claimed in claim 3, wherein:
the quality estimator compares the reconstructed data with source data corresponding to the reconstructed data.

5. The video encoder with real-time quality estimation as claimed in claim 2, wherein:
the quality estimator is coupled to an output port of the inverse-transform unit, to receive the inverse-transformed data as the intermediate data.

6. The video encoder with real-time quality estimation as claimed in claim 5, wherein:
the quality estimator compares the inverse-transformed data with residual data corresponding to the inverse-transformed data.

7. The video encoder with real-time quality estimation as claimed in claim 2, wherein:
the quality estimator is coupled to an output port of the inverse quantization, to receive the inverse-quantized data as the intermediate data.

8. The video encoder with real-time quality estimation as claimed in claim 7 wherein:
the quality estimator compares the inverse-quantized data with transformed residual data corresponding to the inverse-quantized data.

9. The video encoder with real-time quality estimation as claimed in claim 2, wherein:
the playback-level data is output from a final-stage in-loop filter; and
the quality estimator is coupled to an output port of any former-stage in-loop filter to receive the intermediate data.

10. The video encoder with real-time quality estimation as claimed in claim 9, wherein:
the quality estimator compares the intermediate data with source data corresponding to the intermediate data.

11. A video encoding method with real-time quality estimation, comprising:
performing video compression on source data of a video to generate compressed data;
generating playback-level data associated with the compressed data, to be buffered for inter prediction of the video compression, wherein intermediate data is generated associated with the compressed data prior to generation of the playback-level data, and the playback-level data is generated based on the intermediate data; and
performing quality estimation based on the intermediate data for adjusting at least one video compression factor in real time.

12. The video encoding method with real-time quality estimation as claimed in claim 11, further comprising:
corresponding to quantization of the video compression, performing inverse quantization to generate inverse-quantized data;
performing an inverse transform on the inverse-quantized data to generate inverse-transformed data;
based on prediction data predicted in the video compression as well as the inverse-transformed data, generating reconstructed data for intra-prediction of the video compression; and
performing an in-loop filter calculation with at least one stage to process the reconstructed data to generate the playback-level data.

13. The video encoding method as claimed in claim 12, wherein:
the reconstructed data is used as the intermediate data.

14. The video encoding method with real-time quality estimation as claimed in claim 13, further comprising:
comparing the reconstructed data with source data corresponding to the reconstructed data for quality estimation.

15. The video encoding method with real-time quality estimation as claimed in claim 12, wherein:
the inverse-transformed data is used as the intermediate data.

16. The video encoding method with real-time quality estimation as claimed in claim 15, further comprising:
comparing the inverse-transformed data with residual data corresponding to the inverse-transformed data.

17. The video encoding method with real-time quality estimation as claimed in claim 12, wherein:
the inverse-quantized data is used as the intermediate data.

18. The video encoding method with real-time quality estimation as claimed in claim 17, further comprising:
comparing the inverse-quantized data with transformed residual data corresponding to the inverse-quantized data.

19. The video encoding method with real-time quality estimation as claimed in claim 12, wherein:
the playback-level data is output from a final-stage in-loop filter calculation; and
the intermediate data is obtained from an output of any former-stage in-loop filter calculation.

20. The video encoding method with real-time quality estimation as claimed in claim 19, further comprising:
comparing the intermediate data with source data corresponding to the intermediate data.
